(19) United States
(12) Patent Application Publication
(10) Pub. No.: US 2018/0173190 A1
(43) Pub. Date: Jun. 21, 2018

(54) NUMERICAL CONTROLLER

(71) Applicant: FANUC CORPORATION, Minamitsuru-gun (JP)

(72) Inventors: Masaru KUROIWA, Yamanashi (JP); Yasuhito ISHIKAWA, Yamanashi (JP)

(21) Appl. No.: 15/845,186

(22) Filed: Dec. 18, 2017

(30) Foreign Application Priority Data
Dec. 21, 2016 (JP) 2016-247957

(51) Int. Cl. G05B 19/19; G05B 19/404; G05B 19/18; G05B 19/408

(52) U.S. Cl. CPC G05B 19/19; G05B 19/404; G05B 2219/35; G05B 19/4083; G05B 19/182

(57) ABSTRACT

A numerical controller includes: a monitoring unit which monitors a delay time between two machining units after the two machining units simultaneously start operations in the same direction without being in synchronism with each other; a determination unit which determines whether or not the delay time exceeds a predetermined time; and a control unit in which when the delay time exceeds the predetermined time, one of the two machining units is stopped.

This application is based on and claims the benefit of priority from Japanese Patent Application No. 2016-247957, filed on 21 Dec. 2016, the content of which is incorporated herein by reference.

### BACKGROUND OF THE INVENTION

### Field of the Invention

The present invention relates to a numerical controller which has the function of avoiding interference between a plurality of machining units.

### Related Art

For example, as with a twin spindle machine tool, there is a machine tool that includes a plurality of heads in which tools are provided and a plurality of tables on which works are mounted and that simultaneously performs machining on a plurality of works. In the machine tool described above, the feed axes (for example, X axes) of the heads (or the tables) which are machining units may be aligned in the direction of the feed axes, and the movable regions of the aligned feed axes may overlap each other. As a technology for performing control such that in the direction of the aligned feed axes, a plurality of machining units are prevented from colliding (interfering) with each other, synchronous control is present.

Patent Document 1 discloses a numerical controller which performs synchronous control on a plurality of machining units. The numerical controller moves the machining units while keeping a relative distance between the machining units at a synchronous distance so as to avoid the collision of the machining units.

Patent Documents 2 and 3 disclose a numerical controller which performs not synchronous control but simultaneous control on two movable members on a common path. The numerical controller performs, according to individual numerical control programs, feed control on the two movable members which can be moved along a common move path in a direction in which they are moved close to or away from each other. The numerical controller reduces the move allowance range of any one of the two movable members so as to avoid the interference of the movable members.

Patent Document 1: Japanese Unexamined Patent Application, Publication No. H08-320714

Patent Document 2: Japanese Unexamined Patent Application, Publication No. H11-242511

Patent Document 3: Japanese Unexamined Patent Application, Publication No. 2002-328711

### SUMMARY OF THE INVENTION

in synchronous control, since a slave axis is operated according to the movement of a master axis, it is impossible to individually perform tool correction (such as tool position correction, tool length correction and tool diameter correction) on the master axis and the slave axis and to individually use a work coordinate system.

In order to cope with this point, as disclosed in Patent Documents 2 and 3, it can be considered that the synchronous control is not used and that machining units are independently controlled. However, in the controller disclosed in Patent Documents 2 and 3, it is necessary to reduce the move allowance range of any one of the two movable members so as to avoid the interference of the movable members, and thus the controller is not suitable for an application in which a plurality of works are machined simultaneously.

The present invention has an object to provide a numerical controller which can avoid interference between machining units without performing synchronous control when simultaneous machining is performed on a plurality of works with a machine tool having a plurality of machining units.

(1) A numerical controller (for example, a numerical controller 100 which will be described later) is a numerical controller for simultaneously performing machining on at least two works with a machine tool which includes at least two machining units. The numerical controller includes: a monitoring unit (for example, a monitoring unit 114 which will be described later) which monitors a delay time between the two machining units after the two machining units simultaneously start operations in the same direction without being in synchronism with each other; a determination unit (for example, a determination unit 115 which will be described later) which determines whether or not the delay time exceeds a predetermined time; and a control unit (for example, a control unit 112 which will be described later) which stops one of the two machining units or changes a speed of the one of the two machining units, when the delay time exceeds the predetermined time.

(2) The numerical controller described in (1) may further include: a reference calculation unit (for example, a reference calculation unit 113 which will be described later) which calculates the predetermined time based on an allowable relative distance of the two machining units and a command speed, where the allowable relative distance may be a relative distance necessary for preventing collision of the two machining units and may be an allowable approach distance of the two machining units.

(3) In the numerical controller described in (1) or (2), the delay time may be a difference between end point arrival times at which the two machining units arrive at the end point of the same block.

(4) In the numerical controller described in (1) or (2), the monitoring unit may monitor the delay time at one or more checkpoints set at a constant time interval in an intermediate point of a block, and the delay time may be a difference between arrival times based on a difference between arrival distances of the two machining units at the same check point and a command speed.

(5) In the numerical controller described in (1) or (2), the monitoring unit may constantly monitor the delay time, and the delay time may be a delay time based on the remaining distances of the two machining units up to the end point of the same block and a command speed.

(6) In the numerical controller described in (3), when the delay time exceeds the predetermined time, the control unit may stop the one of the machining units which first arrives at the end point of the block.

(7) In the numerical controller described in (4), when the delay time exceeds the predetermined time, the control unit may reduce the speed of the one of the machining units whose arrival distance is long or may accelerate the speed of the one of the machining units whose arrival distance is short.

(8) In the numerical controller described in (5), when the delay time exceeds the predetermined time, the control unit may reduce the speed of the one of the machining units whose remaining distance is short or may accelerate the speed of the one of the machining units whose remaining distance is long.

(9) In the numerical controller described in (6), when a block to be monitored is machining, and a subsequent block is machining, the control unit may be able to select whether or not the one of the machining units is stopped.

According to the present invention, it is possible to provide a numerical controller which can avoid interference between machining units without performing synchronous control when simultaneous machining is performed on a plurality of works with a machine tool having a plurality of machining units.

### BRIEF DESCRIPTION OF THE DRAWINGS

FIG. 1 is a schematic view showing machining units in a machine tool of a machining system according to an embodiment of the present invention.

FIG. 2 is a schematic view showing how the machining units in two systems interfere with each other.

FIG. 3 is a diagram showing the configuration of a control system according to a first embodiment of the present invention.

FIG. 4 is a diagram showing the configuration of a numerical controller according to the first embodiment of the present invention.

FIG. 5 is a flowchart showing an operation by the numerical controller according to the first embodiment.

FIG. 6 is a schematic view showing an interference avoiding operation between machining units by the numerical controller according to the first embodiment.

FIG. 7 is a flowchart showing an interference avoiding operation (before the change of a command speed) between machining units by a numerical controller according to a second embodiment of the present invention.

FIG. 8 is a flowchart showing the interference avoiding operation (after the change of the command speed) between the machining units by the numerical controller according to the second embodiment of the present invention.

FIG. 9 is a schematic view showing the interference avoiding operation between the machining units by the numerical controller according to the second embodiment.

FIG. 10 is a flowchart showing an interference avoiding operation (before the change of a command speed) between machining units by a numerical controller according to a third embodiment of the present invention.

FIG. 11 is a flowchart showing the interference avoiding operation (after the change of the command speed) between the machining units by the numerical controller according to the third embodiment of the present invention.

FIG. 12 is a schematic view showing the interference avoiding operation between the machining units by the numerical controller according to the third embodiment.

### DETAILED DESCRIPTION OF THE INVENTION

An example of embodiments of the present invention will be described below with reference to accompanying drawings. In the drawings, the same or corresponding portions are identified with the same symbols.

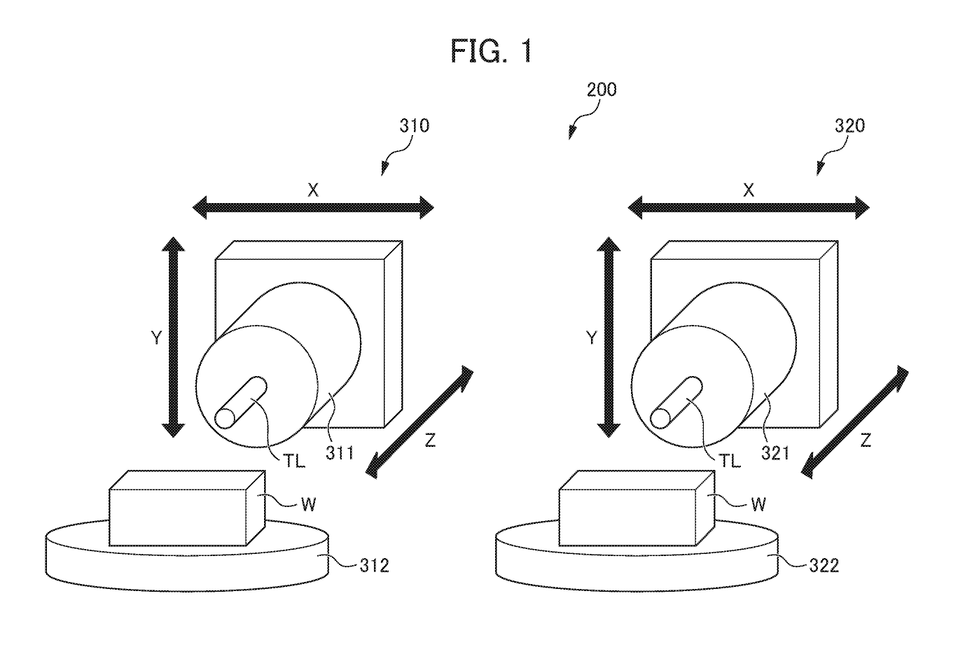

A machine tool which is controlled by a numerical controller according to an embodiment of the present invention will first be described. FIG. 1 is a schematic view showing machining units in the machine tool of a machining system according to the embodiment of the present invention. The machine tool 200 of the present embodiment is a twin spindle machine tool, and includes machining units 310 and 320 in two systems. The machining unit 310 in the first system includes a head 311 which has a tool TL and a table 312 on which a work W is mounted. Likewise, the machining unit 320 in the second systems includes a head 321 which has a tool TL and a table 322 on which a work W is mounted.

In the machine tool 200, the two tools TL are driven to rotate, and thus machining (cutting) can be simultaneously performed on the two works W. In the machine tool 200, the heads 311 and 321 can be moved in the direction of a feed axis (for example, an X axis, a Y axis or a Z axis). The tables 312 and 322 are fixed.

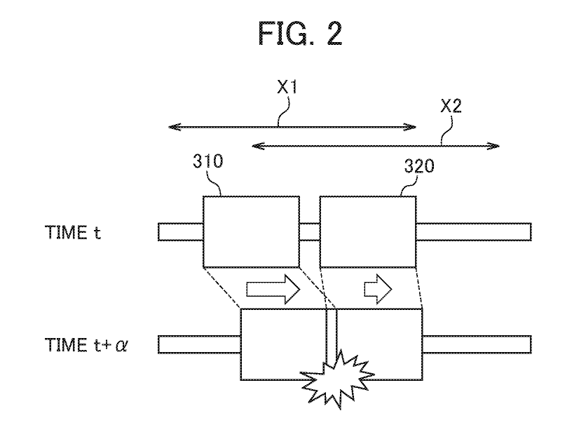

The machining units 310 and 320 are arranged so as to be aligned in the direction of the X axis. Hence, the heads 311 and 321 may collide (interfere) with each other in the direction of the X axis. FIG. 2 is a schematic view showing how the machining units 310 and 320 in the two systems interfere with each other. As shown in FIG. 2, the movable range X1 of the head 311 in the machining unit 310 in the direction of the X axis may overlap the movable range X2 of the head 321 in the machining unit 320 in the direction of the X axis. In this case, even when the heads 311 and 321 are controlled so as to be driven at the same command speed, the actual speed thereof may be different, with the result that when only a predetermined time α has elapsed since a time t, the heads 311 and 321, that is, the machining units 310 and 320 may collide (interfere) with each other.

As a technology for avoiding the interference of the machining units 310 and 320, a synchronous control technology is present. However, in the synchronous control, since a slave axis is operated according to the movement of a master axis, it is impossible to individually perform tool correction (such as tool position correction, tool length correction and tool diameter correction) on the master axis and the slave axis and to individually use a work coordinate system. Hence, in the present invention, the interference between the machining units 310 and 320 is avoided without synchronous control being performed.

### First Embodiment

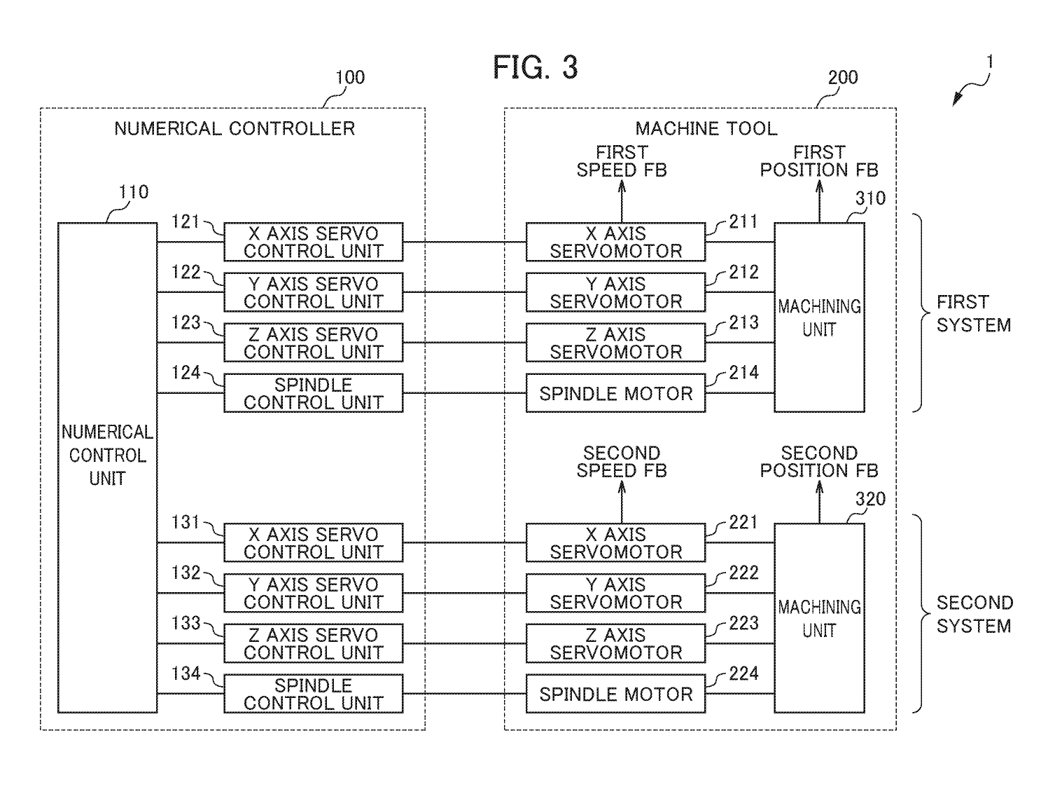

FIG. 3 is a diagram showing the configuration of a machining system according to a first embodiment of the present invention. The machining system 1 includes the numerical controller 100 and the machine tool 200.

As described previously, the machine tool 200 is, for example, a twin spindle machine tool, and includes the machining units 310 and 320 in the two systems. The machine tool 200 also includes an X axis servomotor 211, a Y axis servomotor 212 and a Z axis servomotor 213 for moving the machining unit 310 in the first system in the direction of each of the feed axes and a spindle motor 214 for rotary drive. The machine tool 200 also includes an X axis servomotor 221, a Y axis servomotor 222 and a Z axis servomotor 223 for moving the machining unit 320 in the second system in the direction of each of the feed axes and a spindle motor 224 for rotary drive.

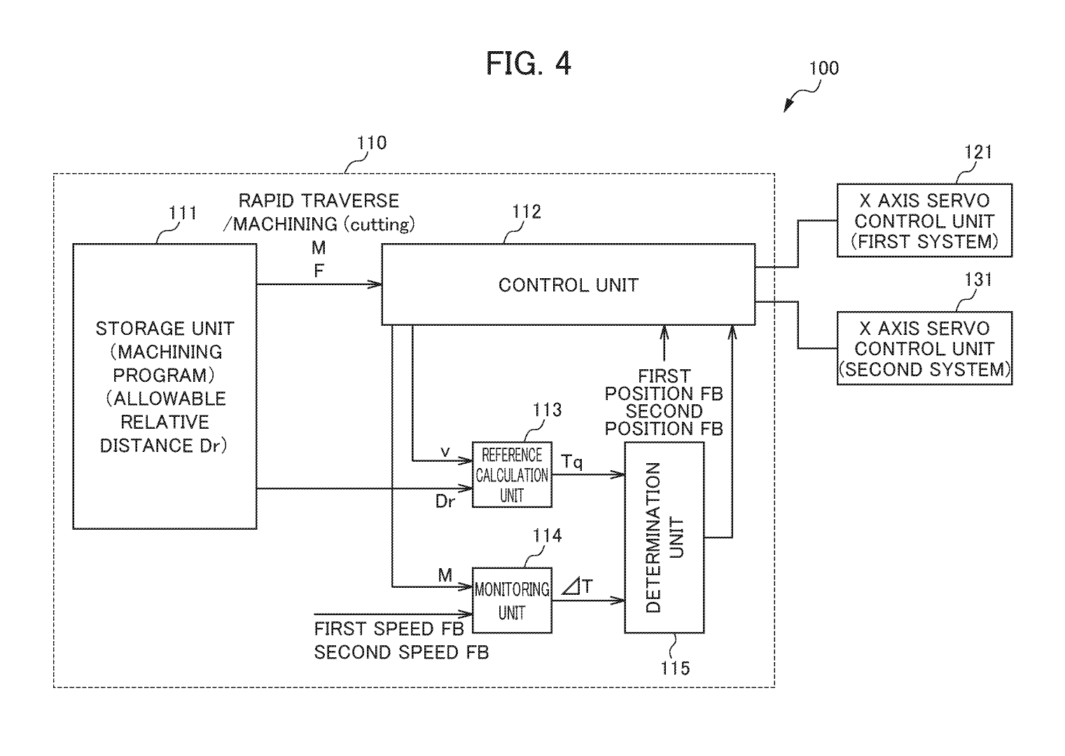

The X axis servomotor 211 includes a speed detector, and supplies a first speed feedback value (which is referred to as a “first speed FB” in FIG. 3 and FIG. 4 described later) to the numerical controller 100. Likewise, the X axis servomotor 221 includes a speed detector, and supplies a second speed feedback value (which as referred to as a “second speed FB” an FIG. 3 and FIG. 4 described later) to the numerical controller 100. Likewise, the other servomotors 212, 213, 222 and 223 supply speed feedback values to the numerical. controller 100.

The machining unit 310 includes a position detector, and supplies a first position feedback value (which is referred to as a “first position FB” in FIG. 3 and FIG. 4 described later) to the numerical controller 100. Likewise, the machining unit 320 includes a position detector, and supplies a second position feedback value (which is referred to as a “second position FB” in FIG. 3 and FIG. 4 described later) to the numerical controller 100.

The numerical controller 100 performs drive control on the motors 211 to 214 and 221 to 224 in the machine tool 200. The numerical controller 100 includes a numerical control unit 110. The numerical controller 100 also includes an X axis servo control unit 121, a Y axis servo control unit 122 and a Z axis servo control unit 123 for performing drive control on the individual axis servomotors 211 to 213 in the first system and a spindle control unit 124 for performing rotary control on the spindle motor 214 in the first system. The numerical controller 100 also includes an X axis servo control unit 131, a Y axis servo control unit 132 and a Z axis servo control unit 133 for performing drive control on the individual axis servomotors 221 to 223 in the second system and a spindle control unit 134 for performing rotary control on the spindle motor 224 in the second system. The numerical controller 100 will be described in detail below.

FIG. 4 is a diagram showing the configuration of the numerical controller 100. In FIG. 4, the Y axis servo control unit 122, the Z axis servo control unit 123, the spindle control unit 124, the Y axis servo control unit. 132, the Z axis servo control unit 133 and the spindle control unit 134 shown in FIG. 3 are omitted. In the following discussion, move control in the direction of the X axis which is a feature of the present invention will be described, and the same is true for move control in the direction of the Y axis and in the direction of the Z axis.

The numerical control unit 110 of the numerical controller 100 includes a storage unit 111, a control unit 112, a reference calculation unit 113, a monitoring unit 114 and a determination unit 115.

The storage unit 111 stores a machining program which is input from the outside. The storage unit 111 also stores an allowable relative distance Dr which is input from the outside. The allowable relative distance Dr is a relative distance between the centers of the machining units 310 and 320 in the two systems in the direction of the X axis, and is a relative distance necessary for preventing the collision of the machining units 310 and 320, that is, an allowable approach distance of the machining units 310 and 320. The storage unit 111 is a rewritable memory such as an EEPROM. The storage unit 111 also stores predetermined software (programs) for realizing various types of functions of the numerical control unit 110.

The control unit 112 reads, from the machining program stored in the storage unit 111, for each system and each block, an operation command (for example, rapid traverse or machining (cutting)), an individual axis stroke P and a command speed F. The control unit 112 determines the distribution stroke of each axis per distribution period based on the individual axis stroke M. The control unit 112 determines a command speed v for output based on the command speed F.

The control unit 112 multiplies, as necessary, the command speed v by an override so as to change the command speed v. The control unit 112 performs, as necessary, tool correction. (such as tool position correction, tool length correction and tool diameter correction) on the individual axis stroke M. The control unit 112 monitors the current positons of the machining units 310 and 320 as necessary based on the first position feedback value, the second position feedback value an a work coordinate system.

The control unit 112 outputs, in each of the system, the distribution stroke and the command speed v as a move command value to the X axis servo control units 121 and 131. In the present embodiment, the same machining (cutting) is simultaneously performed on the two works W, and thus the move command values in the two systems are the same. The control unit 112 controls, based on the determination result of the determination unit 115 which will be described later, the output start and the output. stop of the move command value to the X axis servo control units 121 and 131.

The X axis servo control unit 121 performs drive control on the X axis servomotor 211 based on the move command value, the first speed feedback value and the first position feedback value. Likewise, the X axis servo control unit 131 performs drive control on the X axis servomotor 221 based on the move command value, the second speed feedback value and the second position feedback value.

The reference calculation unit 113 acquires the allowable relative distance Dr stored in the storage unit 111, and acquires the command speed v from the control unit 112. The reference calculation unit 113 calculates, based on the allowable relative distance Dr and the command speed v, an allowable delay time Tq from formula (1) below.

Tq=Dr/v (1)

The allowable delay time Tq is a delay time necessary for preventing the collision of the machining units 310 and 320, that is, an allowable delay time, and is a delay time between the machining units 310 and 320 for determining the interference between the machining units 310 and 320.

The monitoring unit 114 acquires end point arrival times after the start of the simultaneous operations of the machining units 310 and 320 in the two systems in the direction of the X axis without the machining units 310 and 320 in synchronism with each other until each of the machining units 310 and 320 arrives at the end point of a block, and monitors a difference ΔT between the individual end point arrival times. For example, the monitoring unit 114 determines the end point arrival time based on the stroke M and the first speed feedback value (actual speed) or the second speed feedback value (actual speed), in each of the systems, that is, for each of the machining units 310 and 320, and determines a difference ΔT between. these end point arrival times.

The determination unit 115 determines whether or not the difference ΔT between the end point arrival times is equal to or less than the allowable delay time Tg. When ΔT≤Tq, the control unit 112 starts the output of the distribution stroke to each system in the subsequent block immediately after the arrival at the end point of the block. On the other hand, when ΔT>Tq, the control unit 112 stops the output of the distribution stroke to the machining unit in the system which first arrives at the end point of the block. In this way, the control unit 11 stops the machining unit in the system which first arrives at the end point of the block, and performs a waiting function.

The control unit 112, the reference calculation unit 113, the monitoring unit 114 and the determination unit 115 are configured with a computation processor such as a DSP (Digital Signal Processor) or an FPGA (Field-Programmable Gate Array). These functions are realized by executing the predetermined software (programs) stored in the storage unit 111. These functions may be realized by the collaboration of hardware and software or may be realized only by hardware (electronic circuits).

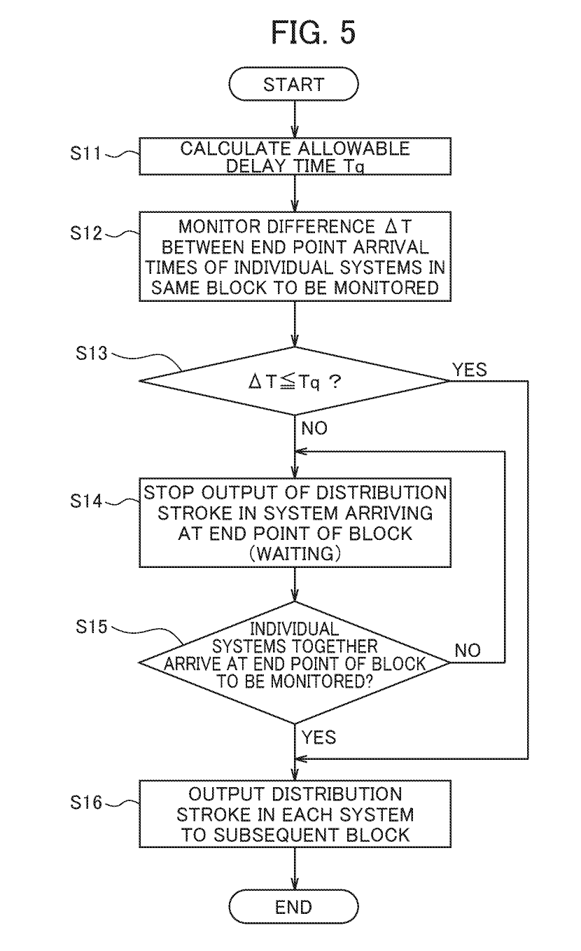

An interference avoidant operation between the machining units 310 and 320 by the numerical controller 100 will next be described. FIG. 5 is a flowchart showing the interference avoiding operation between the machining units 310 and 320 by the numerical controller 100.

The control unit 112 in the numerical control unit 110 of the numerical controller 100 reads, from the machining program stored in the storage unit 111, for each system and each block, the operation command (for example, the rapid traverse or the machining (cutting)), the individual axis stroke M and the command speed F. The control unit 112 determines the distribution stroke of each axis per distribution period based on the individual axis stroke M, and also determines the command speed v for output based on the command speed F. The control unit 112 outputs, in each of the systems, the distribution stroke and the command speed v as the move command value to the X axis servo control units 121 and 131. In this way, the machining units 310 and 320 in the two systems simultaneously start the operations in the direction of the X axis without being in synchronism with each other.

Here, the reference calculation unit 113 acquires the allowable relative distance Dr stored in the storage unit 111, and calculates the allowable delay time Tq based on the allowable relative distance Dr and the command speed v by formula (1) above (S11). The calculation of the allowable delay time Tq may be previously performed both on the rapid traverse processing and on the machining (cutting) processing instead of being performed for each block.

Then, the monitoring unit 114 monitors a difference between the end point arrival times of the machining units 310 and 320 in the individual systems in the same block to be monitored. For example, the monitoring unit 114 determines, based on the stroke M and the first speed feedback value (actual speed) or the second speed feedback value (actual speed), in each of the systems, that is, for each of the machining units 310 and 320, the end point arrival time, and determines a difference ΔT between these end point arrival times (S12).

Then, the determination unit 115 determines whether or not the difference ΔT between the end point arrival times is equal to or less than the allowable delay time Tq (S13). When ΔT is equal to or less than Tq (yes in step S13), in the subsequent block, the machining units 310 and 320 are prevented from colliding (interfering) with each other, with the result that the process proceeds to step S16 described later.

On the other hand, when ΔT is more than Tq (no in step S13), in the subsequent block, the machining units 310 and 320 may collide (interfere) with each other, and thus the control unit 112 stops the output of the distribution stroke to the machining unit 310 in the first system which first arrives at the end point of the block to be monitored (S14). In this way, at the end point of the block to be monitored, that is, the start point of the subsequent block, the machining unit 310 in the first system is stopped, and the waiting function is performed.

The waiting function is performed when the block which is being currently operated is the machining (cutting) and the subsequent block is the rapid traverse; when the block which is being currently operated is the rapid traverse and the subsequent block is also the rapid traverse; and when the block which is being currently operated is the rapid traverse and the subsequent block is the machining (cutting). On the other hand, when the block which is being currently operated is the machining (cutting) and the subsequent block is also the machining (cutting), since the waiting function is performed in the machining, the machining may be affected. In this case, the control unit 112 may select, based on previously set information, whether or not the waiting function is executed, that is, whether or not the output of the distribution stroke is stopped.

Then, the control unit 112 determines, based on the first position feedback value and the second position feedback value, whether or not both the machining units 310 and 320 in the two systems arrive at the end point of the block to be monitored (S15). When the second system has not arrived at the end point of the block to be monitored yet (no in step S15), the process is returned to step S14, and the operations in step S14 and S15 described above are repeated.

On the other hand, when the second system also arrives at the end point of the block to be monitored (yes in step S15), the control unit 112 starts the output of the distribution stroke to the machining units 310 and 320 in the individual systems in the subsequent block. In this way, the operations of the machining units 310 and 320 in the two systems in the subsequent block are started. The operation described above is repeated for each block.

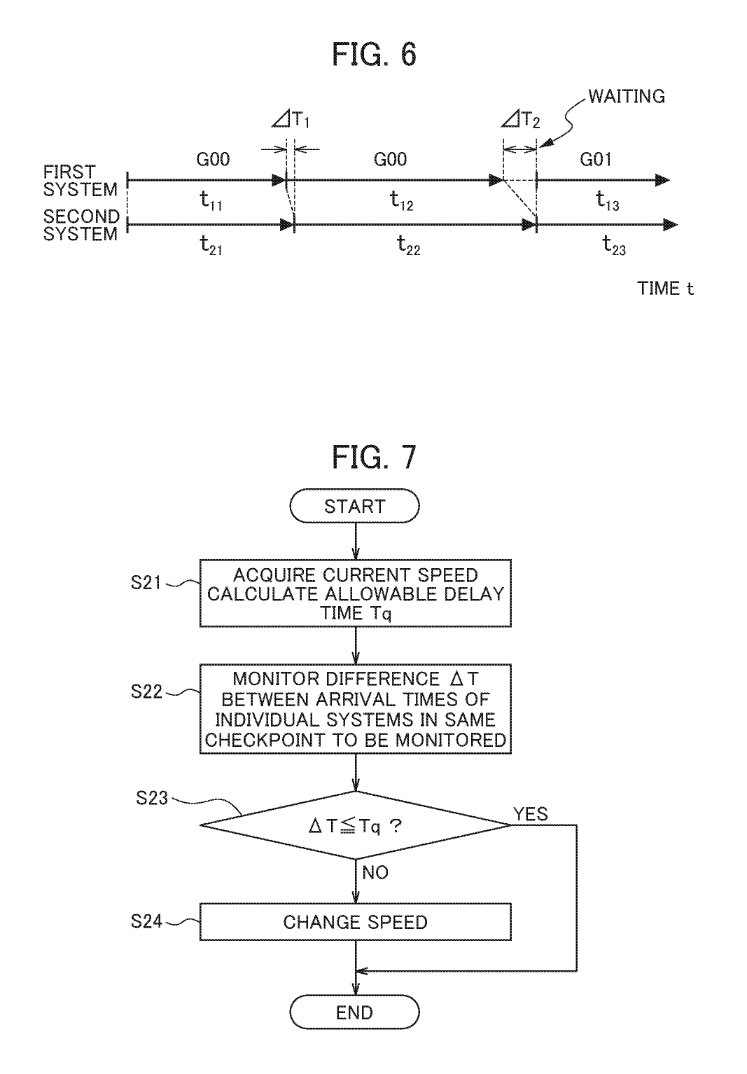

FIG. 6 is a schematic view showing the interference avoiding operation between the machining units by the numerical controller 100. In FIG. 6, G00 indicates a rapid traverse operation command, and G01 indicates a machining (cutting) operation command. Also, tₘₙ indicates a move time in system m in the nth block.

As shown in FIG. 6, when a difference ΔT₁ between the move time of the machining unit 310 in the first system in the first block, that is, an end point arrival time and the move time of the machining unit 320 in the second system in the first block, that is, an end point arrival time t₁₁ is equal to or less than Tq (yes in step S13 of FIG. 5), the operations of the machining units 310 and 320 in the individual systems in the subsequent second block are started without the waiting function being performed (step S16 of FIG. 5).

Then, when a difference ΔT₂ between the move time of the machining unit 310 in the first system in. the second block, that is, an end point arrival time t₁₂ and the move time of the machining unit 320 in the second system in the second block, that is, an end point arrival time t₂₂ is more than Tq (no in step S13 of FIG. 5), the machining unit 310 in the first system which first arrives performs the waiting function at the end point of the second block, that is, the start point of the subsequent third block (step S14 of FIG. 5). Thereafter, when the machining unit 320 in the second system also arrives at the end point of the second block (yes in step S15 of FIG. 5), the operations of the machining units 310 and 320 in the individual systems in the subsequent third block are started (step S16 of FIG. 5).

As described above, in the numerical controller 100 of the present embodiment, the monitoring unit 114 monitors the difference ΔT between the end point arrival times of the machining units 310 and 320 in the block, and when the difference ΔT between the end point arrival times is more than the allowable delay time Tq, since in the subsequent block, the machining units 310 and 320 may interfere with each other, the control unit 112 stops, at the end point of this block, that is, the start point of the subsequent block, the machining unit which first arrives at the end point of the block so as to perform the waiting function. In this way, it is possible to avoid the interference between the machining units 310 and 320.

### Second Embodiment

In the first embodiment, at the end point of the block, the interference of the machining units 310 and 320 is monitored, and when the interference may be produced, the waiting function is performed at the end point of this block, that is, the start point of the subsequent block. By contrast, in a second embodiment, in the intermediate point of the block, the interference of the machining units 310 and 320 is monitored at a constant time interval, and when the interference may be produced, the waiting function is performed immediately.

In the first embodiment, the operation of the faster system is stopped, and thus the interference of the machining units 310 and 320 is avoided. By contrast, in the second embodiment, the command speed of the faster system is changed (reduced), and thus the interference of the machining units 310 and 320 is avoided.

The configuration of a machining system according to the second embodiment is the same as that of the machining system 1 of the first embodiment shown in FIGS. 3 and 4. In the machining system according to the second embodiment, the function and the operation of the numerical controller 100 differ from those of the machining system 1 in the first embodiment.

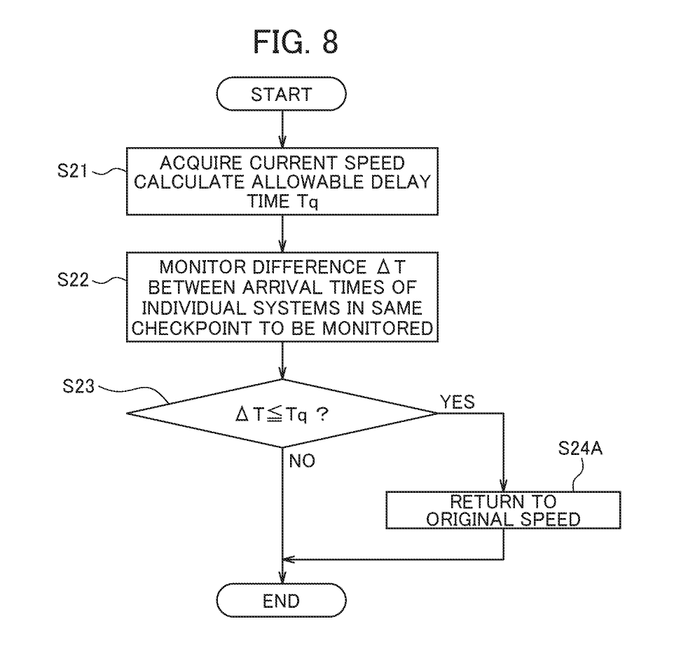

FIG. 7 is a flowchart showing an interference avoiding operation (before the change of the command speed) between the machining units 310 and 320 by the numerical controller 100 according to the second embodiment of the present invention, and FIG. 8 is a flowchart showing the interference avoiding operation (after the change of the command speed) between the machining units 310 and 320 by the numerical controller 100 according to the second embodiment of the present invention.

### Before Change of Command Speed

With reference to FIG. 7, operations before the change of the command speed will be described. The machining units 310 and 320 in the two systems simultaneously start the operations in the direction of the X axis without being in synchronism with each other.

Here, the reference calculation unit 113 acquires the command speed (a rapid traverse speed or a machining (cutting) speed) v which is currently output from the control unit 112, and calculates the allowable delay time Tq based on the command speed v and the allowable relative distance Dr (S21).

Then, the monitoring unit 114 sets checkpoints at a constant time interval in the intermediate point of the block to be monitored, and monitors a difference (delay time) ΔT between the arrival times of the machining units 310 and 320 in the individual systems at the same checkpoint to be monitored. For example, the monitoring unit 114 determines, in each of the systems, based on the distance between the centers of the machining units 310 and 320 at the same checkpoint and the current command speed v, the difference (delay time) ΔT between the arrival times of the machining units 310 and 320 (S22).

Then, the determination unit 115 determines whether or not the difference (delay time) ΔT between the arrival times is equal to or less than. the allowable delay time Tq (S23). When ΔT is equal to or less than Tq (yes in step S23), since the machining units 310 and 320 are thereafter prevented from colliding (interfering) with each other, the control unit 112 does not change the speed.

On the other hand, when ΔT is more than Tq (no in step S23), since the machining units 310 and 320 may thereafter interfere with each other, the control unit 112 changes an override for the machining unit 310 in the first system whose arrival distance is long so as to change (reduce) the command speed (S24). In this way, in the intermediate point of the block, the machining unit 310 in the first system is immediately reduced in speed, and the waiting function is performed.

### After Change of Command Speed

With reference to FIG. 8, operations after the change of the command speed will be described. As described above, the operations in steps S21 to S23 are performed. When n step S23, ΔT is equal to or less than Tq (yes), since the machining units 310 and 320 are thereafter prevented from colliding (interfering) with each other, the control unit 112 returns the override for the machining unit in the first system so as to return the command speed (S24A).

On the other hand, when in step S23, ΔT is more than Tq (no), since the machining units 310 and 320 may still interfere with each other, the control unit 112 does not return the command speed for the machining unit 310 in the first system to the original speed.

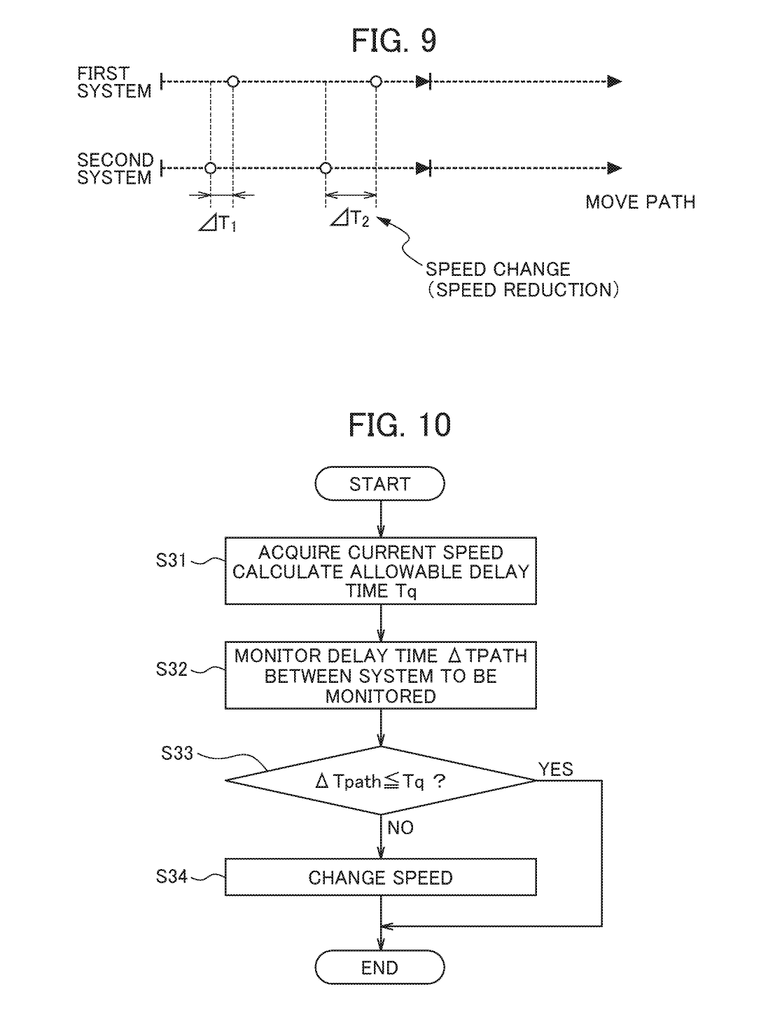

FIG. 9 is a schematic view showing the interference avoiding operation between the machining units 310 and 320 by the numerical controller 100. In FIG. 9, dashed arrows indicate move paths, and circles on the dashed arrows indicate the positions of checkpoints at a constant time interval.

As shown in FIG. 9, when a delay time ΔT₁ between the machining units 310 and 320 in the two systems at a first checkpoint is equal to or less than Tq (yes in step S23 of FIG. 7), the operation is continued without the command speed being changed.

Then, when a delay time ΔT₂ between the machining units 310 and 320 in the two systems at a second checkpoint is more than Tq (no in step S23 of FIG. 7, the command speed of the machining unit 310 in the first system is changed (reduced) (step S24 of FIG. 7). When the delay time ΔT between the machining units 310 and 320 in the two systems at the following checkpoint is equal to or less than Tq (yes in step S23 of FIG. 8), the command speed of the machining unit 310 in the first system is returned to the original speed (step S24A or FIG. 8).

In the numerical controller 100 of the second embodiment, the monitoring unit 114 monitors the delay time ΔT between the machining units 310 and 320 in the intermediate point of the block at a constant time interval, and when the delay time ΔT is more than the allowable delay time Tq, since the machining units 310 and 320 may thereafter interfere with each other, the control unit 112 immediately reduces the operation speed of the machining unit 310 so as to perform the waiting function. In this way, it is possible to avoid the interference between the machining units 310 and 320.

### Third Embodiment

In the second embodiment, in the intermediate point of the block, the interference between the machining units 310 and 320 is monitored at a constant time interval. By contrast, in the third embodiment, the interference between the machining units 310 and 320 is constantly monitored in the block.

The configuration of a machining system according to the third embodiment is the same as that of the machining system 1 of the first embodiment shown in FIGS. 3 and 4. In the machining system according to the third embodiment, the function and the operation of the numerical controller 100 differ from those of the machining system 1 in the first embodiment.

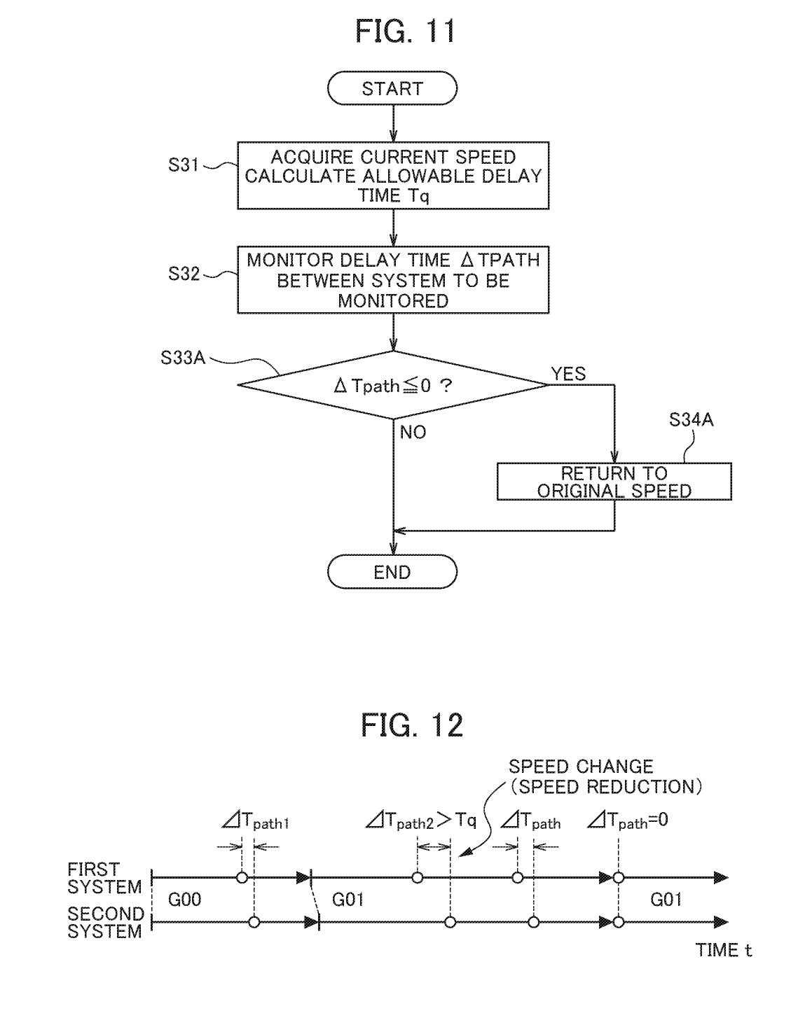

FIG. 10 is a flowchart showing the interference avoiding operation (before the change of the command speed) between the machining units 310 and 320 by the numerical controller 100 according to the third embodiment of the present invention, and FIG. 11 is a flowchart showing the interference avoiding operation (after the change of the command speed) between the machining units 310 and 320 by the numerical controller 100 according to the third embodiment of the present invention.

### Before Change of Command Speed

With reference to FIG. 10, operations before the change of the command speed will be described. First, the machining units 310 and 320 in the two systems simultaneously start the operations in the direction of the X axis without being in synchronism with each other.

Here, the reference calculation unit 113 acquires the command speed (the rapid traverse speed or the machining (cutting) speed) v which is currently output from the control unit 112, and calculates the allowable delay time Tq based on the command speed v and the allowable relative distance Dr (S31).

Then, the monitoring unit 114 constantly monitors a delay time ΔTpath between the machining units 310 and 320 in the two systems to be monitored. For example, the monitoring unit 114 determines, in each of the systems, based on. the first position feedback value and the second position feedback value, the remaining distances d1 and d2 up to the end point of the block. Then, the monitoring unit 114 determines, based on the remaining distances d1 and d2 and the current command speeds v1 and v2, by formula below, the delay time ΔTpath between the machining units 310 and 320 in the two systems (S32). Here, the relationship of the remaining distances d1 and d2 is assumed to be d1>d2.

ΔTpath=d1/v1−d2/v2 (2)

Then, the determination unit 115 determines whether or not the delay time ΔTpath is equal to or less than the allowable delay time Tq (S33). When ΔTpath is equal to or less than Tq (yes in step S33), since the machining units 310 and 320 are thereafter prevented from colliding (interfering) with each. other, the control unit 112 does not change the speed.

On the other hand, when ΔTpath is more than Tq (no in step S33), since the machining units 310 and 320 may thereafter interfere with each other, the control unit 112 changes an override for the machining unit 310 in the first system whose remaining distance is short so as to change (reduce) the command speed v1 (S34). In this way, in the middle of the operation of the block, the machining unit 310 in the first system is immediately reduced in speed, and the waiting function is performed.

The value of the override may be a previously set fixed value or may be set, according to the magnitude of ΔTpath, to a value in proportion to this magnitude. Since acceleration and deceleration are applied to the start point and the end point of the block, the speed monitoring described above may be performed after the command speed is reached.

### After Change of Command Speed

With reference to FIG. 11, operations after the change of the command speed will be described. As described above, the operations in steps S31 and S32 are performed.

Then, the determination unit 115 determines whether or not the delay time ΔTpath is equal to or less than 0 (S33A). When ΔTpath is equal to or less than 0 (yes in step S33A), since the machining units 310 and 320 are thereafter prevented from colliding (interfering) with each other, the control unit 112 returns the override for the machining unit 310 in the first system so as to return the command speed v1 to the original speed (S34A).

On the other hand, when ΔTpath is more than 0 (no in step S33A), since the machining units 310 and 320 may still interfere with each other, the control unit 112 does not return the command speed v1 for the first system to the original speed.

FIG. 12 is a schematic view showing the interference avoiding operation between. the machining units 310 and 320 by the numerical controller 100. As shown in FIG. 12, when a delay time ΔTpath₁ between the machining units 310 and 320 in the two systems is equal to or less than Tq (yes in step S33 of FIG. 10), the operation is continued without the command speed being changed.

Thereafter, when a delay time ΔTpath₂ between the machining units 310 and 320 in the two systems is more than Tq (no in step S33 of FIG. 10), the command speed of the machining unit 310 in the first system is changed (reduced) (step S34 of FIG. 10). Thereafter, when the delay time ΔTpath between the machining units 310 and 320 in the two systems is equal to or less than 0 (yes in step S33A of FIG. 11), the command speed of the machining unit 310 in the first system is returned to the original speed (step S34A of FIG. 11).

In the numerical controller 100 of the third embodiment, the monitoring unit 114 constantly monitors the delay time ΔTpath between the machining units 310 and 320, and when the delay time ΔTpath is more than the allowable delay time Tq, since the machining units 310 and 320 may thereafter interfere with each other, the control unit 112 immediately reduces the operation speed of the machining unit 310 so as to perform the waiting function. In this way, it is possible to avoid the interference between the machining units 310 and 320.

Although the embodiments of the present invention are described above, the present invention is not limited to the embodiments described above. The effects described in the present embodiment are obtained by simply listing preferred effects produced from the present invention, and the effects of the present invention are not limited to the effects described in the present embodiment.

For example, in the embodiments described above, the machine tool which includes the machining units in the two systems so as to simultaneously perform machining on the two works is illustrated. However, the present invention is not limited to this configuration, and can be applied to a machine tool which includes machining units in a plurality of systems so as to simultaneously perform machining on a plurality of works.

In the embodiments described above, the form is illustrated in which the table where the work is mounted is fixed and in which the head including the tool is moved in the direction of the feed axis (for example, the X axis, the Y axis or the Z axis). However, the present invention can also be applied to a form in which the head is fixed and in which the table is moved in the direction of the feed axis.

Although in the second embodiment described above, the command speed of the machining unit in the first system whose operation speed is fast is changed (reduced), the command speed of the machining unit (the former stage in the direction of the move) in the second system whose operation speed is slow may be changed (accelerated).

### EXPLANATION OF REFERENCE NUMERALS

1 machining system
100 numerical controller
110 numerical control unit
111 storage unit
112 control unit
113 reference calculation unit
114 monitoring unit
115 determination unit
121, 131 X axis servo control unit
122, 132 Y axis servo control unit
123, 133 Z axis servo control snit
124, 134 spindle control unit
200 machine tool
211 X axis servomotor
212 Y axis servomotor
213 Z axis servomotor
214 spindle motor
221 X axis servomotor
222 Y axis servomotor
223 Z axis servomotor
224 spindle motor
310, 220 machining unit
311, 321 head
312, 322 table
TL tool
W work

What is claimed is:

1. A numerical controller for simultaneously performing machining on at least two works with a machine tool which includes at least two machining units, the numerical controller comprising:
a monitoring unit which monitors a delay time between the two machining units after the two machining units simultaneously start operations in the same direction without being in synchronism with. each other;
a determination unit which determines whether or not the delay time exceeds a predetermined time; and
a control unit which stops one of the two machining units or changes a speed of the one of the two machining units, when the delay time exceeds the predetermined time.

2. The numerical controller according to claim 1 further comprising: a reference calculation unit which calculates the predetermined time based on an allowable relative distance or the two machining units and a command speed,
wherein the allowable relative distance is a relative distance necessary for preventing collision of the two machining units and is an allowable approach distance of the two machining units.

3. The numerical controller according to claim 1, wherein the delay time is a difference between end point arrival times at which the two machining units arrive at an end point of the same block.

4. The numerical controller according to claim 1, wherein the monitoring unit monitors the delay time at one or more checkpoints set at a constant time interval in an intermediate point of a block, and
the delay time is a difference between arrival times based on a difference between arrival distances of the two machining units at the same check point and a command speed.

5. The numerical controller according to claim 1, wherein the monitoring unit constantly monitors the delay time, and
the delay time is a delay time based on remaining distances of the two machining units up to an end point of the same block and a command speed.

6. The numerical controller according to claim 3, wherein when the delay time exceeds the predetermined time, the control unit stops the one of the machining units which first arrives at the end point of the block.

7. The numerical controller according to claim 4, wherein when the delay time exceeds the predetermined time, the control unit reduces a speed of the one of the machining units whose arrival distance is long or accelerates a speed of the one of the machining units whose arrival distance is short.

8. The numerical controller according to claim 5, wherein when the delay time exceeds the predetermined time, the control unit reduces a speed of the one of the machining units whose remaining distance is short or accelerates a speed of the one of the machining units whose remaining distance is long.

9. The numerical controller according to claim 6, wherein when a block to be monitored is machining (cutting), and a subsequent block is machining (cutting), the control unit can select whether or not the one of the machining units is stopped.
